(19) United States
(12) Patent Application Publication
(10) Pub. No.: US 2024/0289566 A1
(43) Pub. Date: Aug. 29, 2024

(54) ELECTRONIC SHELF LABEL AND SYSTEM, AND METHOD FOR PROCESSING ELECTRONIC SHELF LABEL DATA

(71) Applicant: Hanshow Technology Co., Ltd., Jiaxing, Zhejiang (CN)

(72) Inventors: Shiguo HOU, Jiaxing, Zhejiang (CN); Chaojian LANG, Jiaxing, Zhejiang (CN); Yang ZHAO, Jiaxing, Zhejiang (CN); Jun CHEN, Jiaxing, Zhejiang (CN); Jianguo ZHAO, Jiaxing, Zhejiang (CN)

(21) Appl. No.: 17/633,515

(22) PCT Filed: Aug. 7, 2019
(86) PCT No.: PCT/CN2019/099556

§ 371 Date: Feb. 7, 2022

(51) Int. Cl. G06K 7/10; G06F 1/3293

(52) U.S. Cl. CPC G06K 7/10297; G06F 1/3293

(57) ABSTRACT

The present disclosure provides an electronic shelf label and system, and a method for processing data. The electronic shelf label comprises: an NB-IoT network module configured to receive task data from and/or send electronic shelf label data to a server through an NB-IoT network, send the task data received through the NB-IoT network to a controller and/or receive the electronic shelf label data sent by the controller, and the controller, which is configured to execute a task based on the task data and/or send the electronic shelf label data to the NB-IoT network module. The present disclosure can realize a communication of the electronic shelf label in the NB-IoT network, with low cost and improved communication effect.

### TECHNICAL FIELD

The present disclosure relates to a technical field of electronic shelf label communications, and particularly to an electronic shelf label and an electronic shelf label system, and a method for processing data.

### BACKGROUND

The core technologies of the traditional electronic shelf label data communication are generally based on 2.4G, WIFI, Bluetooth, zigbee, Sub1G, infrared, etc. However, those communication modes have defects. For example, the 2.4G communication mode is based on the 2.4G private protocol to communicate, and the development of the whole application layer and service layer can be extended into cloud management. However, electronic shelf labels in different regions can only be updated based on the smallest unit of stores. The electronic shelf label of each store has to rely on its own wireless private AP (Access Point), and the number of electronic shelf labels is directly proportional to the number of the APs to be deployed, which is not only high in cost, but also difficult for later maintenance upgrade and management. The Bluetooth communication mode has a large power consumption, the Sub1G communication mode has few channels, the infrared communication mode has a high requirement for a network layout that cannot be obstructed, and the WIFI coverage is narrow. Therefore, the communication effects of the above communication modes need to be improved.

In summary, the traditional electronic shelf label data communication has problems of high costs of installation and later maintenance in stores, and poor communication effect.

### SUMMARY

The embodiments of the present disclosure provide an electronic shelf label, which can realize a communication of an electronic shelf label in an NB-IoT network with low cost and good communication effect. The electronic shelf label comprises:
an NB-IoT network module configured to:
   receive task data from a server and/or send electronic shelf label data to the server through an NB-IoT network; and
   send the task data received through the NB-IoT network to a controller and/or receive the electronic shelf label data sent by the controller; and
the controller, which is configured to execute a task based on the task data, and/or send the electronic shelf label data to the NB-IoT network module.

The embodiments of the present disclosure provide a method for processing electronic shelf label data, which can realize a communication of an electronic shelf label in an NB-IoT network with low cost and good communication effect. The method comprises:
receiving task data sent through an NB-IoT network and/or sending electronic shelf label data to a server; and
executing a task based on the task data.

The embodiments of the present disclosure further provide a computer device, comprising a memory, a processor, and a computer program stored in the memory and executable on the processor, wherein the processor is configured to execute the computer program to implement the aforementioned method for processing electronic shelf label data.

The embodiments of the present disclosure further provide a computer-readable storage medium storing a computer program for implementing the aforementioned method for processing electronic shelf label data.

In the embodiments of the present disclosure, the NB-IoT network module receives task data from a server and/or sends electronic shelf label data to the server through the NB-IoT network; sends the task data received through the NB-IoT network to the controller and/or receives the electronic shelf label data sent by the controller; the controller executes a task based on the task data and/or sends the electronic shelf label data to the NB-IoT network module. In the electronic shelf label, it is unnecessary to install or maintain any AP, so the cost is low. The coverage of the NB-IoT network is wide, so the communication effect of sending and receiving data through the NB-IoT network is improved.

### BRIEF DESCRIPTION OF DRAWINGS

The drawings illustrated here provide a further understanding of the present disclosure, and constitute a part of the present disclosure rather than limitations thereto. In the drawings,

FIG. 1 is a schematic diagram of an electronic shelf label in an embodiment of the present disclosure;

FIG. 2 is a schematic diagram of an electronic shelf label system in an embodiment of the present disclosure;

FIG. 3 is a flowchart of a method for processing electronic shelf label data in an embodiment of the present disclosure.

### DESCRIPTION OF EMBODIMENTS

For a clear understanding of the objectives, technical features and effects of the embodiments of the present invention, specific embodiments will now be described with reference to the drawings. The described embodiments are intended only to schematically illustrate and explain this invention and do not limit the scope of this invention.

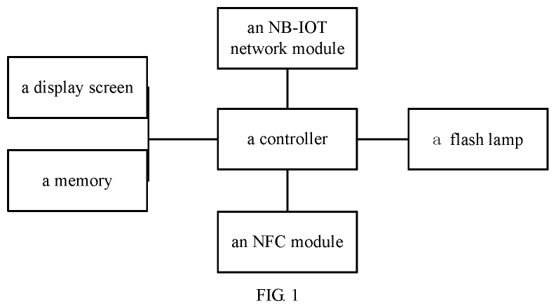

FIG. 1 is a schematic diagram of an electronic shelf label in an embodiment of the present disclosure. As illustrated in FIG. 1, the electronic shelf label comprises: an NB-IoT network module configured to:
receive task data from a server and/or send electronic shelf label data to the server through an NB-IoT network; and
send the task data received through the NB-IoT network to a controller and/or receive the electronic shelf label data sent by the controller; and
the controller, which is configured to execute a task based on the task data, and/or send the electronic shelf label data to the NB-IoT network module.

In the embodiment of the present disclosure, the NB-IoT network module receives the task data from and/or sends the electronic shelf label data to the server through the NB-IoT network; sends the task data received through the NB-IoT network to the controller and/or receives the electronic shelf label data sent by the controller; the controller executes the task based on the task data and/or sends the electronic shelf label data to the NB-IoT network module. In the electronic shelf label, it is unnecessary to install or maintain any AP, so the cost is low. The coverage of the B-IoT network is wide, so the communication effect of sending and receiving data through the NB-IoT network is improved.

In the electronic shelf label, the electronic shelf label data may include many kinds, such as heartbeat data of the electronic shelf label, stored content, identifier, size information, etc. The NB-IoT (Narrow Band Internet of Things) is an important branch of the Internet. The NB-IoT network, built in a cellular network, consumes a bandwidth of only about 180 KHz and can be directly deployed in a GSM network, a UMTS network or an LTE network to reduce a deployment cost and realize a smooth upgrade. The NB-IoT network, also known as a Low-Power Wide Area (LPWA) network, supports a cellular data connection of a low-power device in a wide area network. The NB-IoT network supports an efficient connection of a device with a long standby time and a high requirement for network connection. A battery life of an NB-IoT device can be increased to at least 10 years, while a very comprehensive coverage of an indoor cellular data connection can be provided. Therefore, the embodiments of the present disclosure can achieve a good communication effect by receiving the task data from and/or sending the electronic shelf label data to the server through the NB-IoT network. In the embodiments of the present disclosure, the NB-IoT network module is a universal interface, which can establish a communication relationship with any communication manufacturer, and has no limitation.

In one embodiment, the controller is further configured to generate network registration information, and send the network registration information and electronic shelf label identification information to the NB-IoT network module;
the NB-IoT network module is further configured to send the network registration information and the electronic shelf label identification information to the server through the NB-IoT network, receive and forward electronic shelf label registration result data to the controller, and receive the task data from and/or send the electronic shelf label data to the server through the NB-IoT network, in response to the electronic shelf label registration result data indicating a successful registration.

In the above embodiment, after the electronic shelf label is powered on, the controller may firstly check whether the electronic shelf label has been registered in the NB-IoT network, and generate the network registration information if the check result indicates that the electronic shelf label has not been registered, and send the network registration information and the electronic shelf label identification information to the NB-IoT network module. Next, the NB-IoT network module sends the network registration information and the electronic shelf label identification information to the server through the NB-IoT network to register the electronic shelf label, and then the NB-IoT network module receives and forwards the electronic shelf label registration result data to the controller. If the check result indicates that the electronic shelf label has been registered, the task data may be received from and/or the electronic shelf label data may be sent to the server directly through the NB-IoT network.

In specific implementation, the electronic shelf label may support other communication modes besides the communication through the NB-IoT network, and one embodiment will be given below.

In one embodiment, the electronic shelf label further comprises an NFC module configured to:
receive task data from and/or send electronic shelf label data to an NFC device or an APP device;
send the task data to the controller and/or receive the electronic shelf label data sent by the controller.

In the above embodiment, the NFC (Near Field Communication) is a short-range and high-frequency radio technology, which operates at a frequency of 13.56 MHz in a distance of 20 cm, with a transmission speed of 106 Kbit/s, 212 Kbit/s or 424 Kbit/s. At present, the near-field communication has passed the ISO/IEC IS 18092 international standard, the ECMA-340 standard and the ETSI TS 102 190 standard. The NFC adopts active and passive reading modes. The NFC device is generally an NFC chip, while software of the NFC chip can be programmed independently with strong universality and consistency, and can be developed by users according to actual needs. APP is an abbreviation of ‘application’, which usually refers to application software on a mobile phone, or is called as a mobile client. In addition, there are many online APP development platforms. The NFC module can receive the task data sent by the NFC device or the APP device, and then send the task data to the controller, which executes a task based on the task data. In addition, the NFC module can also receive the electronic shelf label data sent by the controller, and then send the electronic shelf label data to the NFC device or the APP device. The NFC module enables the communication mode of the electronic shelf label to be more flexible, thereby being suitable for different scenes.

In one embodiment, the controller is further configured to:
control the electronic shelf label into a low power consumption state or a wake-up state according to a preset wake-up mode which comprises a periodic wake-up mode and a timed wake-up mode;
perform, when the electronic shelf label is in the wake-up state, a compression process on the electronic shelf label data to generate a compressed package of the electronic shelf label data.

In the above embodiment, when the preset wake-up mode is the periodic wake-up mode, a wake-up period may be dynamically configured by a user according to his own business requirement, e.g., a maximum wake-up period may be configured as 2 weeks, or a default wake-up period may be adopted, such as 24 hours. When the preset wake-up mode is the timed wake-up mode, it may be configured to wake up the electronic shelf label at a specific moment in a specific time zone. When the electronic shelf label is controlled to be in the low power consumption state, the power consumption of the electronic shelf label can be reduced and the service life thereof can be prolonged. In addition, when the electronic shelf label is in the wake-up state, the electronic shelf label data is compressed so as to be subsequently sent in the form of a compressed package, thereby improving sending efficiency, saving sending time, and reducing power consumption of the electronic shelf label.

In one embodiment, the NFC module is further configured to:
wake up the electronic shelf label upon a preset wake-up condition, when the electronic shelf label is in the low power consumption state.

In the above embodiment, the NFC module wakes up the electronic shelf label upon the preset wake-up condition, which means a forced external wake-up of the electronic shelf label, and the preset wake-up condition can be formulated according to actual needs.

In one embodiment, the NB-IoT network module is further configured to:
stop receiving and sending the task data and the electronic shelf label data, when the electronic shelf label is in the low power consumption state;
receive the task data from and/or send the electronic shelf label data to the server in batches through the NB-IoT network, when the electronic shelf label is in the wake-up state.

In the above embodiment, when the electronic shelf label is in the low power consumption state, the reception and sending of the task data and the electronic shelf label data are stopped, i.e., the NB-IoT network module is disabled and shut down, thereby reducing the power consumption of the electronic shelf label and prolonging the service life thereof. When the electronic shelf label is in the low power consumption state, it is necessary to receive and send data. In order to prevent the service life of the battery module of the electronic shelf label from being reduced due to the long-term data reception by the electronic shelf label, a manner of receiving and sending data in batches may be adopted, i.e., the data may be received from and sent to the server in batches through the NB-IoT network, including the reception of the task data and/or the sending of the electronic shelf label data on a time basis or a volume basis. The above manner can ensure that no data will be lost while prolonging the service life of the battery module.

In one embodiment, the NB-IoT network module is further configured to:
receive a compressed package of the task data sent by the server in batches through the NB-IoT network, and/or send the compressed package of the electronic shelf label data to the server in batches through the NB-IoT network, when the electronic shelf label is in the wake-up state.

The above manner of receiving the task data and sending the electronic shelf label data in the form of compressed package can greatly reduce the sending and receiving time, improve sending efficiency and save power consumption of the electronic shelf label.

In one embodiment, the NB-IoT network module is further configured to:
obtain the compressed package of the electronic shelf label data corresponding to a transmission breakpoint, and send the compressed package corresponding to the transmission breakpoint to the server in batches through the NB-IoT network, when the electronic shelf label is in the wake-up state.

The sending process of the compressed package of the electronic shelf label data is a resume transmission process from a breakpoint, which records a last data transmission interruption point, i.e., a transmission breakpoint, identify the compressed package of the electronic shelf label data corresponding to the transmission breakpoint, and re-sends the compressed package of the electronic shelf label data corresponding to the transmission breakpoint in batches. The above process can prevent the loss of the electronic shelf label data in the transmission process.

In one embodiment, the NFC module is further configured to:
stop receiving and sending the task data and the electronic shelf label data, when the electronic shelf label is in the low power consumption state;
receive the task data from and/or send the electronic shelf label data to the NFC device or the APP device in batches, when the electronic shelf label is in the wake-up state.

In the above embodiment, when the electronic shelf label is in the low power consumption state, the NFC module stops receiving and sending the task data and the electronic shelf label data, i.e., the NFC module is disabled, thereby reducing the power consumption of the electronic shelf label and prolonging the service life thereof. When the electronic shelf label is in the low power consumption state, it is necessary to receive and send data. In order to prevent the service life of the battery module of the electronic shelf label from being reduced due to the long-term data reception by the electronic shelf label, a manner of receiving and sending data in batches may be adopted, i.e., receiving the task data from and/or sending the electronic shelf label data to the NFC device or the APP device in batches, including the reception of the task data and/or the sending of the electronic shelf label data on a time basis or a volume basis. The above manner can ensure that no data will be lost while prolonging the service life of the battery module.

In one embodiment, the NFC module is further configured to:
receive a compressed package of the task data of the NFC device or the APP device in batches, and/or send the compressed package of the electronic shelf label data to the NFC device or the APP device in batches, when the electronic shelf label is in the wake-up state.

The above manner of receiving the task data and sending the electronic shelf label data in the form of compressed package can greatly reduce the sending and receiving time, improve sending efficiency and save power consumption of the electronic shelf label.

In one embodiment, the NFC module is further configured to:
obtain the compressed package of the electronic shelf label data corresponding to a transmission breakpoint, and send the compressed package of the electronic shelf label data corresponding to the transmission breakpoint to the NFC device or the APP device in batches, when the electronic shelf label is in the wake-up state.

The sending process of the compressed package of the electronic shelf label data is a resume transmission process from a breakpoint related to the NFC module, which records a last data transmission interruption point, i.e., a transmission breakpoint, identify the compressed package of the electronic shelf label data corresponding to the transmission breakpoint, and re-sends the compressed package of the electronic shelf label data corresponding to the transmission breakpoint in batches. The above process can prevent the loss of the electronic shelf label data in the transmission process.

In specific implementation, the electronic shelf label can execute the functions of lamp flickering, screen display, storage, etc. according to specific circumstances. One embodiment will be given below.

In one embodiment, the electronic shelf label further comprises one of or any combination of a flash lamp, a display screen and a memory, wherein,
the controller is further configured to control, when the electronic shelf label comprises the flash lamp and the task data comprises a light-up task, the flash lamp to light up according to the light-up task;
the controller is further configured to control, when the electronic shelf label comprises the display screen and the task data comprises a display task, the display screen to display according to the display task;
the controller is further configured to control, when the electronic shelf label comprises a memory and the task data comprises a storage task, the memory to store to-be-stored information in the storage task according to the storage task.

In one embodiment, the flash lamp comprises an LED lamp.

In the above embodiment, the color of the LED lamp may be yellow-green or other colors, and the LED lamp may adopt different flashing strategies according to actual needs, which can be freely defined or predefined. Of course, it can be understood that the LED lamp is only an example, and any other type of flash lamp may also be used as the flash lamp, while relevant variations shall fall within the scope of the present disclosure.

In one embodiment, the display screen comprises an electronic paper display screen.

Of course, it can be understood that the electronic paper display screen is only an example, and other types of electronic screens may also be used as the display screen, such as an electronic paper ink display screen which has the characteristics of supporting local update and split view, and can achieve a significant display effect, while relevant variations shall fall within the scope of the present disclosure.

In one embodiment, the electronic shelf label further comprises a battery module configured to supply power to the electronic shelf label, such as a high-capacity lithium battery.

In the electronic shelf label proposed by the embodiment of the present disclosure, the NB-IoT network module receives the task data from and/or sends the electronic shelf label data to the server through the NB-IoT network; sends the task data received through NB-IoT network to the controller and/or receives the electronic shelf label data sent by the controller; the controller executes the task based on the task data and/or sends the electronic shelf label data to the NB-IoT network module. In the electronic shelf label, it is unnecessary to install or maintain any AP, so the cost is low. The coverage of the NB-IoT network is wide, so the communication effect of sending and receiving data through the NB-IoT network is improved. In addition, the electronic shelf label further comprises an NFC module, which can receive the task data from and/or send the electronic shelf label data to the NFC device or the APP device, so that the communication mode of the electronic shelf label is more flexible, thereby being suitable for different scenes.

In addition, the controller controls the electronic shelf label to be in the low power consumption state or the wake-up state according to the preset wake-up mode, thereby reducing the power consumption of the electronic shelf label and prolonging the service life thereof. When the electronic shelf label is in the wake-up state, the NB-IoT network module receives the task data from and/or sends the electronic shelf label data to the server in batches through the NB-IoT network, and the NFC module receives the task data from and/or sends the electronic shelf label data to the NFC device or the APP device in batches, thereby prolonging the service life of the battery module and ensuring that no data will be lost.

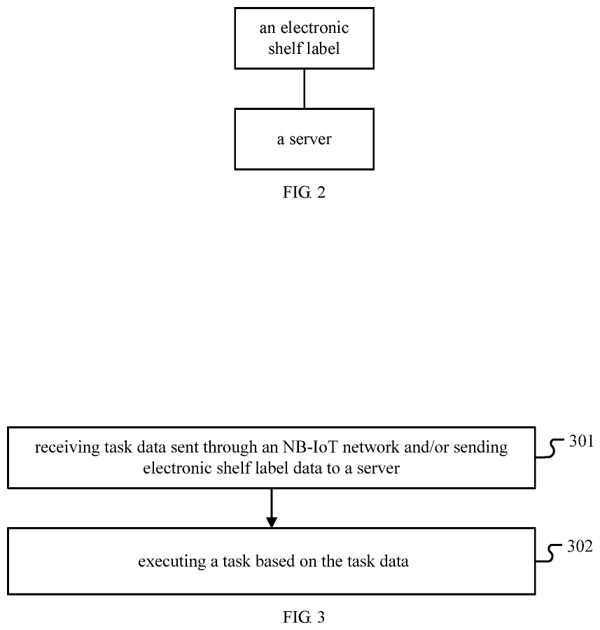

The embodiments of the present disclosure further propose an electronic shelf label system. FIG. 2 is a schematic diagram of the electronic shelf label system in an embodiment of the present disclosure. As illustrated in FIG. 2, the system comprises the aforementioned electronic shelf label and a server, wherein the server is configured to send task data to and/or receive electronic shelf label data from an electronic shelf label through an NB-IoT network.

In specific implementation, the server further receives network registration information and electronic shelf label identification information sent by the electronic shelf label through the NB-IoT network, completes a registration of the electronic shelf label, and sends a registration result to an NB-IoT network module of the electronic shelf label through the NB-IoT network.

In one embodiment, the server is further configured to send the task data to the electronic shelf label in batches through the NB-IoT network.

In the above process, the server may divide the task data into a plurality of compressed packages, and then send the task data to the electronic shelf label in batches. It is also possible to obtain the compressed packages of the electronic shelf label data corresponding to a transmission breakpoint of a server, and send the compressed packages of the electronic shelf label data corresponding to the transmission breakpoint to the electronic shelf label in batches through the NB-IoT network.

In one embodiment, the electronic shelf label system further comprises an NFC device and/or an APP device, wherein the NFC device is configured to send the task data to and/or receive the electronic shelf label data from the electronic shelf label, and the APP device is configured to send the task data to and/or receive the electronic shelf label data from the electronic shelf label.

In one embodiment, the NFC device is further configured to send the task data to the electronic shelf label in batches, and the APP device is further configured to send the task data to the electronic shelf label in batches.

In the above embodiment, the NFC device may divide the task data into a plurality of compressed packages, and then send the task data to the electronic shelf label in batches. It is also possible to obtain the compressed packages of the electronic shelf label data corresponding to a transmission breakpoint of an NFC, and send the compressed packages of the electronic shelf label data corresponding to the transmission breakpoint of the NFC to the electronic shelf label in batches. The APP device may also divide the task data into a plurality of compressed packages, and then send the task data to the electronic shelf label in batches. It is also possible to obtain the compressed packages of the electronic shelf label data corresponding to a transmission breakpoint of an APP, and send the compressed packages of the electronic shelf label data corresponding to the transmission breakpoint of the APP to the electronic shelf label in batches.

In one embodiment, the server is a cloud server.

The Elastic Compute Service (ECS) is a simple, efficient, secure and reliable computing service with flexible processing power, and its management mode is simpler and more efficient than that of a physical server. Users can quickly create or release any number of ECSs without purchasing hardware. The ECS can store a large volume of data of the electronic shelf label, with fast response speed and processing speed, and high efficiency of communication with the electronic shelf label. Of course, it can be understood that the ECS is only an example, and any other type of server, such as an ordinary physical server, may also be used as the server, and relevant variations shall fall within the scope of the present disclosure.

In the electronic shelf label system proposed by the embodiment of the present disclosure, the NB-IoT network module receives the task data from and/or sends the electronic shelf label data to the server through the NB-IoT network, sends the task data received through the NB-IoT network to the controller and/or receives the electronic shelf label data sent by the controller; the controller executes the task based on the task data and/or sends the electronic shelf label data to the NB-IoT network module. In the electronic shelf label, it is unnecessary to install or maintain any AP, so the cost is low. The coverage of the NB-IoT network is wide, so the communication effect of sending and receiving data through the NB-IoT network is improved. In addition, the server may be the ECS, which can store a large volume of data of the electronic shelf label, with fast response speed and processing speed, and high efficiency of communication with the electronic shelf label. In addition, the task data sent by the NFC device or the APP device may also be received, so that the communication mode of the electronic shelf label is more flexible, thereby being suitable for different scenes.

In addition, the controller controls the electronic shelf label to be in the low power consumption state or the wake-up state according to the preset wake-up mode, thereby reducing power consumption of the electronic shelf label and prolonging service life thereof. When the electronic shelf label is in the wake-up state, the NB-IoT network module receives the task data from and/or sends the electronic shelf label data to the server in batches through the NB-IoT network, and the NFC module receives the task data from and/or sends the electronic shelf label data to the NFC device or the APP device in batches, thereby prolonging the service life of the battery module and ensuring that no data will be lost.

Based on the same inventive concept, an embodiment of the present disclosure further provide a method for processing electronic shelf label data, as described in the following embodiments. Since the principle of technical solution of the method is similar to that of the electronic shelf label, the electronic shelf label as described above may be referred to for implementation of the method, and the repetitive description is omitted herein.

FIG. 3 is a flowchart of a method for processing electronic shelf label data in an embodiment of the present disclosure. As illustrated in FIG. 3, the method comprises:
step 301: receiving task data sent through an NB-IoT network and/or sending electronic shelf label data to a server;
step 302: executing a task based on the task data.

In one embodiment, the method further comprises:
generating network registration information;
sending the network registration information and electronic shelf label information to the server through the NB-IoT network, wherein the network registration information and the electronic shelf label information serves to obtain electronic shelf label registration result data; and
receiving the task data sent through the NB-IoT network and/or sending the electronic shelf label data to the server, in response to the electronic shelf label registration result data indicating a successful registration.

In one embodiment, the method further comprises:
receiving the task data sent by an NFC device or an APP device; and/or
sending the electronic shelf label data to the server.

In one embodiment, the method further comprises:
controlling the electronic shelf label into a low power consumption state or a wake-up state according to a preset wake-up mode which comprises a periodic wake-up mode and a timed wake-up mode.

In one embodiment, the method further comprises:
waking up the electronic shelf label upon a preset wake-up condition, when the electronic shelf label is in the low power consumption state.

In one embodiment, the method further comprises:
stopping receiving and sending the task data and the electronic shelf label data, when the electronic shelf label is in the low power consumption state.

In one embodiment, the method further comprises:
receiving the task data from and/or sending the electronic shelf label data to the server in batches through the NB-IoT network, when the electronic shelf label is in the wake-up state.

In one embodiment, receiving the task data from and/or sending the electronic shelf label data to the server in batches through the NB-IoT network comprises:
receiving a compressed package of the task data sent by the server in batches through the NB-IoT network, and/or sending a compressed package of the electronic shelf label data to the server in batches through the NB-IoT network.

In one embodiment, sending the compressed package of the electronic shelf label data to the server in batches through the NB-IoT network comprises:
obtaining the compressed package of the electronic shelf label data corresponding to a transmission breakpoint, and sending the compressed package of electronic shelf label data corresponding to the transmission breakpoint to the server in batches through the NB-IoT network.

In one embodiment, the method further comprises:
receiving the task data from and/or sending the electronic shelf label data to the NFC device or the APP device in batches, when the electronic shelf label is in the wake-up state.

In one embodiment, receiving the task data from and/or sending the electronic shelf label data to the NFC device or the APP device in batches comprises:
receiving the task data from and/or sending the electronic shelf label data to the NFC device or the APP device in batches.

In one embodiment, the method further comprises:
obtaining a compressed package of the electronic shelf label data corresponding to a transmission breakpoint, and sending the compressed package of the electronic shelf label data corresponding to the transmission breakpoint to the NFC device or the APP device in batches.

In one embodiment, the task data comprises one of or any combination of a light-up task,
a display task and a storage task;
executing the task based on the task data comprises:
controlling, when the task data comprises the light-up task, a flash lamp to light up according to the light-up task;
controlling, when that task data comprises the display task, a display screen to display according to the display task;
controlling, when the task data comprises the storage task, the memory to store to-be-stored information in the storage task according to the storage task.

In the method proposed by the embodiment of the present disclosure, the task data is received from and/or the electronic shelf label data is sent to the server through the NB-IoT network, and the task is executed based on the task data. In the above method, it is unnecessary to install or maintain any AP, so the cost is low. The coverage of the NB-IoT network is wide, so the communication effect of sending and receiving data through the NB-IoT network is improved. In addition, the task data may be received from the NFC device or the APP device, so that the communication mode of the electronic shelf label is more flexible, thereby being suitable for different scenes.

In addition, the controller controls the electronic shelf label to be in the low power consumption state or the wake-up state according to the preset wake-up mode, thereby reducing power consumption of the electronic shelf label and prolonging service life thereof. When the electronic shelf label is in the wake-up state, the NB-IoT network module receives the task data from and/or sends the electronic shelf label data to the server in batches through the NB-IoT network, and the NFC module receives the task data from and/or sends the electronic shelf label data to the NFC device or the APP device in batches, thereby prolonging service life of the battery module and ensuring that no data will be lost.

Those skilled in the art should understand that the embodiments of this disclosure can be provided as methods, systems or computer program products. Therefore, this disclosure may be implemented in the form of fully-hardware embodiments, fully-software embodiments, or combined software-hardware embodiments. In addition, this disclosure may employ the form of a computer program product implemented on one or more computer storage medium (including but not limited to disk memory, CD-ROM, and optical memory) containing computer programming code.

This disclosure is set forth by referring to flow charts and/or block diagrams for the methods, devices (systems), and computer program products of the embodiments. It should be understood that each process and/or block of the flow charts and/or block diagrams as well as combinations of the processes and/or boxes of the flow charts and/or block diagrams can be realized by computer program instructions. These computer program instructions can be provided to general-purpose computers, special-purpose computers, embedded processors or the processors of other programmable data processing devices to produce a machine, so that an apparatus for implementing the functions designated in one or more processes of the flowcharts and/or one or more blocks of the block diagrams can be produced by the instructions executed by the processor of the computer or other programmable data processing device.

These computer program instructions can also be stored in a computer-readable storage medium which can guide a computer or other programmable data processing device to operate in a particular way, so that an article of manufacture comprising an instruction apparatus can be produced by the instructions stored in the storage medium, with the instruction apparatus implementing the functions designated in one or more processes of the flowcharts and/or one or more blocks of the block diagram.

These computer program instructions may also be loaded onto a computer or other programmable data processing device to make the computer or other programmable data processing device perform a sequence of computer-implemented operations, so that the instructions executed by the computer or other programmable data processing device realize one or more processes of the flowcharts and/or one or more blocks of the block diagram.

The purpose, technical features and technical effects of the present disclosure have been further described above by means of some embodiments. It should be understood that the embodiments are meant to facilitate understanding of the principles of the present disclosure, and those skilled in the art can make any modifications based on the teachings of this disclosure. This specification shall not be construed as any limitation to the present disclosure.

1. An electronic shelf label, comprising:
an NB-IoT network module configured to:
receive task data from a server and/or send electronic shelf label data to the server through an NB-IoT network; and
send the task data received through the NB-IoT network to a controller and/or receive the electronic shelf label data sent by the controller; and
the controller, which is configured to execute a task based on the task data, and/or send the electronic shelf label data to the NB-IoT network module.

2. The electronic shelf label according to claim 1, wherein
the controller is further configured to generate network registration information, and send the network registration information and electronic shelf label identification information to the NB-IoT network module;
the NB-IoT network module is further configured to send the network registration information and the electronic shelf label identification information to the server through the NB-IoT network, receive and forward electronic shelf label registration result data to the controller, and receive the task data from the server and/or send the electronic shelf label data to the server through the NB-IoT network, in response to the electronic shelf label registration result data indicating a successful registration.

3. The electronic shelf label according to claim 2, further comprising an NFC module configured to:
receive the task data from and/or send the electronic shelf label data to an NFC device or an APP device;
send the task data to the controller and/or receive the electronic shelf label data sent by the controller.

4. The electronic shelf label according to claim 3, wherein the controller is further configured to:
control the electronic shelf label into in a low power consumption state or a wake-up state according to a preset wake-up mode which comprises a periodic wake-up mode and a timed wake-up mode;
perform, when the electronic shelf label is in the wake-up state, a compression process on the electronic shelf label data to generate a compressed package of the electronic shelf label data.

5. The electronic shelf label according to claim 4, wherein the NFC module is further configured to:
wake up the electronic shelf label upon a preset wake-up condition, when the electronic shelf label is in the low power consumption state.

6. The electronic shelf label according to claim 4, wherein the NB-IoT network module is further configured to:
stop receiving and sending the task data and the electronic shelf label data, when the electronic shelf label is in the low power consumption state;
receive the task data from and/or send the electronic shelf label data to the server in batches through the NB-IoT network, when the electronic shelf label is in the wake-up state.

7. The electronic shelf label according to claim 6, wherein the NB-IoT network module is further configured to:
receive a compressed package of the task data sent by the server in batches through the NB-IoT network, and/or send the compressed package of the electronic shelf label data to the server in batches through the NB-IoT network, when the electronic shelf label is in the wake-up state.

8. The electronic shelf label according to claim 7, wherein the NB-IoT network module is further configured to:
obtain the compressed package of the electronic shelf label data corresponding to a transmission breakpoint, and send the compressed package corresponding to the transmission breakpoint to the server in batches through the NB-IoT network, when the electronic shelf label is in the wake-up state.

9. The electronic shelf label according to claim 4, wherein the NFC module is further configured to:
stop receiving and sending the task data and the electronic shelf label data, when the electronic shelf label is in the low power consumption state;
receive the task data from and/or send the electronic shelf label data to the NFC device or the APP device in batches, when the electronic shelf label is in the wake-up state.

10. The electronic shelf label according to claim 9, wherein the NFC module is specifically configured to:
receive a compressed package of the task data from the NFC device or the APP device in batches, and/or send the compressed package of the electronic shelf label data to the NFC device or the APP device in batches, when the electronic shelf label is in the wake-up state.

11. The electronic shelf label according to claim 10, wherein the NFC module is specifically configured to:
obtain the compressed package of the electronic shelf label data corresponding to a transmission breakpoint, and send the compressed package corresponding to the transmission breakpoint to the NFC device or the APP device in batches, when the electronic shelf label is in the wake-up state.

12. The electronic shelf label according to claim 1, further comprising one of or any combination of a flash lamp, a display screen and a memory, wherein,
the controller is further configured to control, when the electronic shelf label comprises the flash lamp and the task data comprises a light-up task, the flash lamp to light up according to the light-up task;
the controller is further configured to control, when the electronic shelf label comprises the display screen and the task data comprises a display task, the display screen to display according to the display task;
the controller is further configured to control, when the electronic shelf label comprises the memory and the task data comprises a storage task, the memory to store to-be-stored information in the storage task according to the storage task.

13. (canceled)

14. (canceled)

15. (canceled)

16. An electronic shelf label system, comprising:
the electronic shelf label according to any one of claim 1; and
a server configured to send task data to and/or receive electronic shelf label data from the electronic shelf label through an NB-IoT network.

17. (canceled)

18. The electronic shelf label system according to claim 16, further comprising:
an NFC device configured to send the task data to and/or receive the electronic shelf label data from the electronic shelf label; and/or
an APP device configured to send the task data to and/or receive the electronic shelf label data from the electronic shelf label.

19. (canceled)

20. (canceled)

21. A method for processing electronic shelf label data, comprising:
receiving task data sent through an NB-IoT network and/or sending electronic shelf label data to a server; and
executing a task based on the task data.

22. The method according to claim 21, further comprising:
generating network registration information;
sending the network registration information and electronic shelf label information to the server through the NB-IoT network, wherein the network registration information and the electronic shelf label information serves to obtain electronic shelf label registration result data; and
receiving the task data sent through the NB-IoT network, and/or sending the electronic shelf label data to the server, in response to the electronic shelf label registration result data indicating a successful registration.

23. The method according to claim 21, further comprising:
receiving the task data sent by an NFC device or an APP device; and/or
sending the electronic shelf label data to the server.

24. The method according to claim 23, further comprising:
controlling the electronic shelf label into a low power consumption state or a wake-up state according to a preset wake-up mode which comprises a periodic wake-up mode and a timed wake-up mode.

25. (canceled)

26. The method according to claim 24, further comprising:
stop receiving and sending the task data and the electronic shelf label data when the electronic shelf label is in the low power consumption state.

27. The method according to claim 24, further comprising:
receiving the task data from and/or sending the electronic shelf label data to the server in batches through the NB-IoT network, when the electronic shelf label is in the wake-up state.

28.-35. (canceled)
